(19) United States
(12) Patent Application Publication
(10) Pub. No.: US 2006/0007943 A1
(43) Pub. Date: Jan. 12, 2006

(54) Method and system for providing site independent real-time multimedia transport over packet-switched networks

(76) Inventor: Ronald D. Fellman, San Diego, CA (US)

Correspondence Address: DALINA LAW GROUP, P.C., 7910 IVANHOE AVE. #325, LA JOLLA, CA, 92037, US

(21) Appl. No.: 11/177,507

(22) Filed: Jul. 7, 2005

Related U.S. Application Data
(60) Provisional application No. 60/521,821, filed on Jul. 7, 2004.

(51) Int. Cl. H04L 12/56

(52) U.S. Cl. 370/400; 370/509

(57) ABSTRACT

Embodiments of the invention enable minimum latency site independent real-time video transport over packet switched networks. Some examples of real-time video transport are video conferencing and real-time or live video streaming. In one embodiment of the invention, a network node transmits live or real-tine audio and video signals, encapsulated as Internet Protocol (IP) data packets, to one or more nodes on the Internet or other IP network. One embodiment of the invention enables a user to move to different nodes or move nodes to different locations thereby providing site independence. Site independence is achieved by measuring and accounting for the jitter and delay between a transmitter and receiver based on the particular path between the transmitter and receiver independent of site location. The transmitter inserts timestamps and sequence numbers into packets and then transmits them. A receiver uses these timestamps to recover the transmitter's clock. The receiver stores the packets in a buffer that orders them by sequence number. The packets stay in the buffer for a fixed latency to compensate for possible network jitter and/or packet reordering. The combination of timestamp packet-processing, remote clock recovery and synchronization, fixed-latency receiver buffering, and error correction mechanisms help to preserve the quality of the received video, despite the significant network impairments generally encountered throughout the Internet and wireless networks.

This patent application takes priority from U.S. Provisional Patent Application Ser. No. 60/521,821 entitled “Method And System For Providing Site Independent Real-Time Video Transport Over Packet-Switched Networks” filed Jul. 7, 2004 which is hereby incorporated herein by reference.

### BACKGROUND OF THE INVENTION

1. Field of the Invention

Embodiments of the invention relate generally to network based audio and video transport over packet switched networks. More specifically, but not by way of limitation, embodiments of the invention relate to quality of service (QoS) methods and systems that enable minimal latency site independent audio and video transport over the Internet or wireless IP networks.

2. Description of the Related Art

Video conferencing and real-time or live audio and video streaming applications currently suffer from significant network impairments generally encountered throughout the Internet and wireless networks. For example, the jitter on a shared Internet connection, such as through cable modems and wireless Wi-Fi (IEEE 802.11abg), may exceed hundreds of milliseconds. Such network connections often experience the loss of several percent of transmitted packets. Network impairments of this magnitude severely degrade video quality and generally limit the use of current video conferencing and live video streaming systems.

Current video conferencing systems generally employ specialized audio/video codec hardware devices located at fixed locations and interconnected by means of a point-to-point ISDN line, T1 link, or other dedicated telecommunications data link. The use of a dedicated, point-to-point data link limits availability to only the fixed end points of the link and increases communications costs in comparison with Internet data connections, which share communications resources and services among many users. Furthermore, the use of specialized audio/video codec devices increases equipment cost overhead and limits flexibility.

Current video conferencing systems generally employ constant bit rate (CBR) video encoding to match the limited throughput of dedicated telecommunications data links. However, CBR video encoding inserts additional queuing delays to buffer the large bit rate variations between encoding a key frame versus a difference frame. This additional queuing adds increased latency in comparison to variable bit rate (VBR) encoding.

In other systems, streaming video servers use TCP/IP to transmit video over the Internet. Because TCP/IP has indeterminate latency characteristics, the streaming client has large jitter buffers of 5 to 10 seconds or more to compensate for TCP/IP jitter. Another disadvantage of TCP/IP is that a server can not multicast a stream to multiple clients. Without a multicast means the TCP/IP streaming server uses more bandwidth with higher latency required to account for the inherent TCP/IP timing problems.

Companies such as Tandberg and Harmonic offer streaming video solutions that run over special IP networks having only minor impairments. Such IP networks generally have jitter of less than 10 milliseconds and only occasional packet loss on the order of 1 loss per billion packets. However, such a network is not site-independent since these networks would only have a limited number of access points. The transmitter and receiver must have direct connections to one of these access points.

### BRIEF SUMMARY OF THE INVENTION

Embodiments of the present invention provide minimal latency site-independence for applications involving the transport of real-time or live audio and video transport. Two examples of such applications are video conferencing and real-time video streaming. Site-independence as used herein is defined as the loosening or near elimination of geographical and location-specific constraints on the transmission and reception of real-time or live video and audio. For site independence in one embodiment, a user is allowed to move to different nodes or nodes are allowed to move to different locations. Some examples of nodes are a video conferencing server, a real-time or live streaming server, a laptop or desktop PC, a cell phone, or a PDA. Site independence is achieved by maintaining the quality of service (QoS) of the transported video and audio signals by means of time-synchronized error recovery and jitter removal mechanisms.

For the purposes of this disclosure, video conferencing means any system capable of delivering live, two-way video and audio streams across a distance from one networked node to another. This definition includes live video streaming applications and systems where the return feeds are disabled or otherwise not implemented, so as to also allow only one-way live video and audio. Live video streaming applications also includes transmitting stored content from hard drives as a real-time data stream and also includes systems where the resolution or quality of the video or audio may be asymmetric between the upstream and downstream nodes. Thus, a video conferencing system of this definition may not be symmetric. For example, it may comprise a server node and a client node. For the purposes of this disclosure in an asymmetric system, we shall denote as a “first node” that device that generally is configured to deliver the highest resolution or quality audio and video. In the specific case of a symmetric video conferencing system, any single terminal device of two or more terminal devices involved in a video conference may be designated as the “first node” and the others designated as “second node” devices.

In one embodiment of the invention, a first node can be a video conferencing server or real-time or live video streaming server at either a fixed or a mobile location. The second node can be a mobile system with network communications access to the first node, such as a laptop, or PDA or cell phone with a wireless Internet modem means, or a PC at a fixed location, but having a wireless or wireline connection to the Internet. A system that uses cell phones for both the first and second nodes provides an example where both nodes are site independent.

One advantage of embodiments of the invention is the elimination of the need for specialized hardware devices, and their associated costs, for use as video conferencing terminals, as well as the ability to transmit and receive over nearly any available networked connection. Embodiments of the invention achieve these advantages by replacing video conference systems requiring custom hardware with standard personal computers (PCs) running video conferencing software communicating with packetized data over the Internet or other Internet Protocol (IP) networks in place of contiguous signal streams transmitted over dedicated communications links. The low cost and flexibility of using a PC as the audio/video codec coupled with the widespread availability, low cost, and high bandwidth of the Internet as the communications medium creates a more cost-effective interactive video system that eliminates location constraints and supplies a far broader set of complementary functionality. Embodiments of the invention may further comprise wireless networking IP interfaces that enable further ubiquity and site-independence.

Neither PCs nor the Internet have been designed to handle the demands of live video conferencing. As a result, embodiments of the invention use of specialized synchronization and error recovery mechanisms to overcome deficiencies that otherwise severely limit the use of PCs and the Internet in video conferencing. The video and audio means of embodiments of the invention utilize a novel combination of synchronization, jitter buffering, packet reordering, and error correction mechanisms, collectively called Quality of Service (QoS) mechanisms. The QoS mechanisms utilized in embodiments of the invention provide the requisite signal conditioning that allows the use of standard PCs and Internet connections in video conferencing and real-time or live audio and video streaming applications.

Precise time synchronization and the use of fixed-duration buffer delays employed in the QoS mechanism of embodiments of the invention provides advantages over other live or interactive video conferencing and streaming systems. The QoS mechanism relies upon the time synchronization between the transmitter of a first node and the receiver of a second node, and uses this shared time clock as a component within its buffering mechanisms as a means to restore packet order, remove jitter, and recover lost packets.

One embodiment of the present invention implements QoS mechanisms as a software module. Streaming audio and/or video-data is encapsulated as Internet Protocol (IP) packets and combined by a multiplexer into a single stream of packets for processing by the QoS mechanisms and transported over a wide-area IP network, such as the Internet. This QoS component at a transmitting node includes packet time stamping and clock recovery means integrated with and controlling packet buffering and error recovery mechanisms.

The QoS mechanism of the transmitter inserts sequence numbers into the outbound video/audio data packets and timestamps the packets immediately prior to transmitting them. The QoS mechanism of the receiver uses this timestamp, read from the stream of received packets, to recover the transmitter's clock. The QoS mechanism of the receiver stores the packets in a buffer, ordering them by sequence number to maintain correct readout packet order. The packets stay in the buffer for a fixed latency as calculated by embodiments of the invention to compensate for possible network jitter and/or packet reordering with minimal possible latency. Packets are removed from the buffer with a fixed latency that is determined by using the timestamps in the packet and the transmitter's recovered clock. Packets are next stored in an error correction buffer for a fixed or finite time, depending on the error correction algorithm. The combination of the above said packet-processing helps to preserve the quality of the received video, despite the possible introduction of significant network impairments, such as that which is likely to occur over and unconditioned best-effort packet network, such as the Internet.

Depending upon application constraints, and prior to packetization, said audio and video streams may, optionally, be encoded, compressed, and/or encrypted, or may not have undergone through any processing other than digitization and formatting.

### BRIEF DESCRIPTION OF THE DRAWINGS

FIG. 1. System diagram showing the connection of a first node of the present invention, incorporating QoS timing and encoding mechanisms, connected via the Internet to a second node PC system of the present invention, incorporating complementary QoS decoding mechanisms to provide error and timing recovery to overcome Internet network impairments.

FIG. 2. Block diagram of a transmitter of the present invention incorporating QoS encoding means and time stamping means.

FIG. 3. Block diagram of a receiver of the present invention incorporating clock recovery, buffering means to restore packet order and eliminate jitter, and QoS decoding means to effect error recovery for dropped packets.

### DETAILED DESCRIPTION OF THE INVENTION

Embodiments of the present invention provide minimal latency site-independence for applications requiring the transport of live or real-time audio and video signals. Two examples of such applications are video conferencing and real-time or live audio and video streaming applications. Site-independence as used herein is defined as the loosening or near elimination of geographical and location-specific constraints on the transmission and reception of real-time or live video and audio. For site independence in one embodiment, a user is allowed to move to different nodes or nodes are allowed to move to different locations. Some examples of nodes are a video conferencing server, a real-time or live streaming server, a laptop or desktop PC, a cell phone, or a PDA. Site independence is achieved by maintaining the quality of service (QoS) of the transported video and audio signals by means of time-synchronized error recovery and jitter removal mechanisms.

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Any mathematical references made herein are approximations that can in some instances be varied to any degree that enables the invention to accomplish the function for which it is designed. In other instances, specific features, quantities, or measurements well-known to those of ordinary skill in the art have not been described in detail so as not to obscure the invention. Readers should note that although examples of the invention are set forth herein, the claims, and the full scope of any equivalents, are what define the metes and bounds of the invention.

In one embodiment of the invention, a first node with a network connection to the Internet, or other wide-area Internet Protocol (IP) network, transmits live audio and video signal data to a second node on the Internet or other network link with connectivity to said first node. Either node can be a video conferencing or live video streaming system at a fixed or mobile location, such as a personal computer with video conferencing software, a specialized video conferencing device, or a live video streaming device. Either node may also be a mobile device with wireless network communications access to the Internet and running software of the present invention, such as a cell phone, a PDA, or a portable personal computer. In all cases, audio can be sent along with the video and kept in exact lip-sync by means of timing recovery mechanisms.

Site independence is possible if both first and second nodes have network communications access to either the Internet, or to a wide-area IP network having a broad geographical distribution of access points, or to a wireless IP network with either Internet connectivity or connectivity to said wide-area IP network.

The first node and the second node can each act as a transmitter and a receiver, sending and receiving video and audio simultaneously. As such, the transmitter and receiver as described herein apply equally to both the first and second nodes of the present invention.

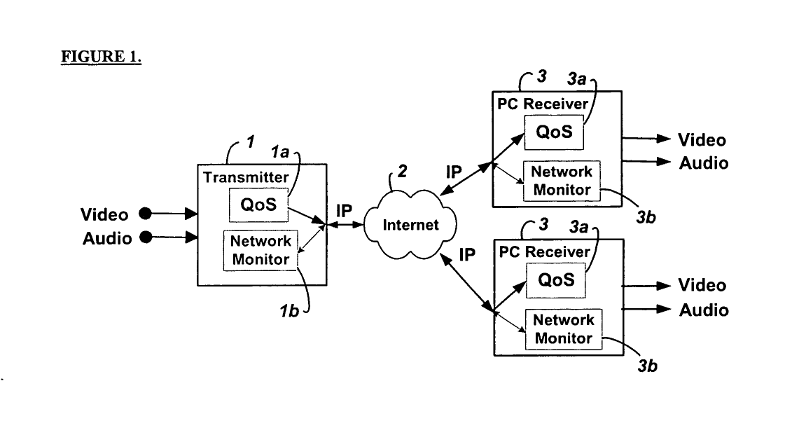

FIG. 1 provides a system diagram of one embodiment of the invention. A transmitter of a first (or second) node 1 accepts video and/or audio signals from an analog or digital sensor or live capture device, such as a video camera, microphone, or other such device that provides a continuous stream of audio/video signals. Implemented within this node, is a component responsible for generating a continuous stream of IP data packets from said audio and video signals (packetization component) as one skilled in the art will recognize may be constructed by placing data into IP packets and transmitting these packets from a socket for example. The packetization component may include none, some, or all of the following signal processing functionalities: digitization, filtering, echo or ghost suppression, encoding, companding, compression, multiplexing, and/or encryption, depending upon the application constraints, such as link speeds or security requirements, and the form of the video and audio input signals. The IP packet stream passes through a Quality-of-Service (QoS) block 1a in the transmitter where it is processed and fed to an IP network. An IP network 2, such as the Internet, transports the packetized signal data to a receiver 3 at a second (or first) node.

The feature of embodiments of the invention that allow for site independence is the QoS sub-block in the transmitter 1a and QoS sub-block in the receiver 3a of the nodes. These QoS blocks incorporate mechanisms that condition the packet stream to provide a means to recover the original stream timing due to queuing or other random or variable delays within the network 2 and to recover data that the IP network 2 may have lost. The mechanisms in these QoS blocks further provide for minimal latency calculations that set the time that packets are held in receiver 3a before delivery to the client, while still providing optimal error recovery functionality.

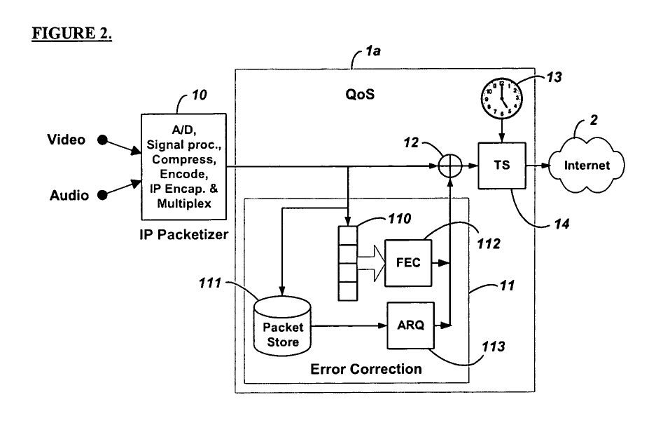

FIG. 2 provides a more detailed diagram of the transmitter QoS block 1a. The incoming audio and video signals are digitized if necessary and fed to a packetization component 10 as previously described. An Error Correction component 11 comprises error correction buffer 110, packet store 111, forward error correction module 112 and automatic repeat request (ARQ) module 113 for processing and maintaining a moving copy of prior packets for later possible use by various error correction mechanisms. One skilled in the art will recognize that any component capable of forward error correction or automatic resending of data may be utilized as a pluggable component within error correction component 11.

The packets generated by the packetization component 10 combine at 12 with any packets generated by the error correction component 11, and pass through a timestamp component 14 immediately before emerging onto the network 2. A clock means 13 drives the timestamp component 14. The timestamp component 14 also includes a counter component that generates sequence numbers, thereby maintaining a count of the number of outgoing packets and providing a method for stamping a unique sequence number into each packet. The QoS block of each receiver 3a uses the timestamp to recover the transmitter's clock and the sequence number to restore packet order. The introduction of a sequence number and a timestamp for multimedia packets of any type consistent between 1a and 3a may be employed in embodiments of the invention. Furthermore, any method of causing a local clock at a receiver to maintain synchronization with the clock at the transmitter may be utilized as one skilled in the art will recognize.

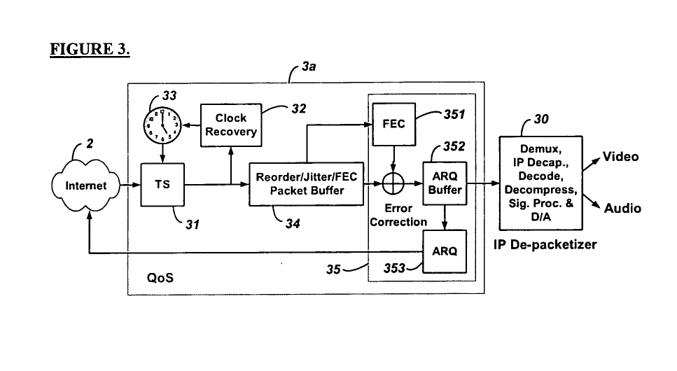

FIG. 3 shows details of the receiver QoS block 3a. At the receiver, a timestamp component 31 driven by a local clock 33 immediately stamps incoming packets with their time of arrival. The local clock 33 is kept synchronized with the transmitter's clock 13 through a clock recovery mechanism 32. Any clock recovery mechanism may be utilized with more sophisticated methods providing more accurate recovery as will be appreciated to one skilled in the art. After being time stamped by 31, buffer 34 stores the incoming packets and uses the sequence number to restore the original packet order. Received packets stay in this buffer 34 for an adjustable fixed holding time to compensate for possible network-induced jitter and/or packet reordering, and to allow sufficient time for FEC checksum packets to arrive, if FEC is employed. The adjustable fixed holding time value, when added to the packet's timestamp, produces a release time in time units corresponding to the synchronized time of local clock 33. At the passing of this holding time, the buffer 34 releases each packet to the Error Correction means 35.

By delaying the release of each packet by this additional holding time, the receiver has additional tine to accommodate network jitter (the maximum variation of packet arrival times), out-of-ordered packets, and the error recovery mechanisms of 35. Holding each packet for this additional adjustable fixed amount of time, yields packet timing as observed at IP De-packetizer 30 equal to the time of transmission at IP Packetizer 10 plus the fixed latency time introduced by the adjustable fixed holding time. The adjustable fixed holding time term means a fixed holding time that may be set for a given period of time until another calculate warrants the adjustment of the holding time to another fixed value that holds until recalculation. A network monitoring mechanism 3b continuously measures the timing through network 2, such as network jitter and round-trip time, in order to adjust the holding time to the minimum optimal amount, thereby recreating the original stream with minimal latency. As seen in FIG. 1, the two receivers generally comprise different paths over the internet and generally comprise fixed latency times that differ from one another.

Calculation of the proper adjustable fixed holding time value, as accomplished by network monitoring means 3b, may be performed by sending a test stream of packets from transmitter QoS block 1a to receiver QoS block 3a and calculating the maximum observed jitter and round trip time for example. As mentioned above, ongoing monitoring of jitter, round trip time, and packet loss patterns can adjust the fixed holding time from time to time to automatically compensate for varying network packet impairments. For example a video conference started during lunch hour, when network usage is light, and might have minor network impairments that only require a small holding time. But suddenly at the end of lunch, when users return to work and resume using the network, the impairments may change and the holding time would then have to be increased.

Various combinations of error correction mechanisms may be employed within 35. In one embodiment, forward error correction means 351 detects missing packets and attempt to use received checksum packets to restore these missing packets. Either in conjunction with the FEC means 351 or as an alternative to FEC, an Automatic Repeat reQuest (ARQ) means 353 or any other means of requesting missing packets for example detects the loss of packets (after FEC, if employed, had a chance to first correct any losses it detected) and issue a request back through the network 2 to the transmitter to replace the missing packets. However, ARQ means 353 uses additional buffering means 352 to delay the packet stream for one or more round-trip packet times in order to allow sufficient time for a replacement request to travel upstream to the transmitter and for the re-transmitted replacement packet to find its way back to the receiver's ARQ Buffer 352. Once the replacement packet enters ARQ Buffer 352, the replacement packet is placed in its proper order just in time for outputting as part of the multi-media packet stream to an IP de-packetizer means 30. An IP de-packetizer means 30 performs the inverse operations as the IP packetizer means 10 wherein it converts the multimedia packet stream into its original raw, uncompressed audio and/or video signal components.

The combination of the above said packet-processing helps to preserve the quality of the received video, despite the possible introduction of significant network impairments, such as that which is likely to occur over and unconditioned best-effort packet network, such as the Internet.

It should be understood that the programs, processes, methods, systems and apparatus described herein are not related or limited to any particular type of computer apparatus (hardware or software), unless indicated otherwise. Various types of general purpose or specialized computer apparatus may be used with or perform operations in accordance with the teachings described herein.

In view of the wide variety of embodiments to which the principles of the invention can be applied, it should be understood that the illustrated embodiments are exemplary only, and should not be taken as limiting the scope of embodiments of the invention. For example, the Steps of the flow diagrams may be taken in sequences other than those described, and more or fewer elements or components may be used in the block diagrams. In addition, the present invention can be practiced with software, hardware, or a combination thereof.

The claims should not be read as limited to the described order or elements unless stated to that effect. Therefore, all embodiments that come within the scope and spirit of the following claims and equivalents thereto are claimed as the invention.

What is claimed is:

1. A system for providing site independent real-time multimedia transport over packet-switched networks comprising:
a network;
a first node selected from a group of nodes wherein said first node is coupled with said network and wherein said first node comprises:
a packet store;
an automatic repeat request module coupled with said packet store;
a time clock; and,
a timing synchronizer configured to time stamp a first packet and a second packet obtained from said automatic repeat request module with a time parameter obtained from said time clock;
a plurality of second nodes selected from said group of nodes wherein said plurality of second nodes are coupled with said network and wherein said plurality of second nodes comprises:
a receiver time clock;
a receiver timing synchronizer coupled with said receiver time clock;
a clock recovery module coupled with said receiver timing synchronizer;
a receiver automatic repeat request buffer;
a receiver automatic repeat request module coupled with said receiver automatic repeat request buffer;
said first node configured to transmit to said plurality of said second nodes; and,
said plurality of second nodes configured to restore packet order, remove jitter and recover lost packets and where said each of said plurality of second nodes further comprise a network monitor configured to calculate and update a minimum hold time based on network jitter and round-trip time.

2. The system of claim 1 said group of nodes comprises network enabled computing devices comprising a programmable central processing unit.

3. The system of claim 2 wherein said network enabled computing devices comprise a video conference server, a real-time or live video streaming server, a laptop, a personal computer, a personal digital assistant or a cell phone.

4. The system of claim 1 said first node and said second node are heterogeneous nodes.

5. The system of claim 1 said first node and said second node are homogeneous nodes.

6. The system of claim 1 said first node further comprises a filtering module.

7. The system of claim 1 said first node further comprises a ghost suppression module.

8. The system of claim 1 said first node further comprises an encoding module.

9. The system of claim 1 said first node further comprises a companding module.

10. The system of claim 1 said first node further comprises a compression module.

11. The system of claim 1 said first node further comprises a multiplexing module.

12. The system of claim 1 said first node further comprises an encryption module.

13. A method for providing site independent real-time multimedia transport over packet-switched networks comprising:
encapsulating multimedia data as a first packet and a second packet;
combining said first packet and said second packet into a stream of packets;
stamping said first packet and said second packet with a time stamp and a sequence number; and,
transmitting said stream of packets over an network to a plurality of receivers.

14. The method of claim 13 further comprising:
receiving a network monitor packet sent from a receiver node.

15. The method of claim 13 further comprising:
calculating a jitter time using a network monitor packet sent from a receiver node.

16. A method for providing site independent real-time multimedia transport over packet-switched networks comprising:
stamping a first packet, a second packet and at least one forward error correction packet with a time stamp of a time of arrival;
recovering a transmitter clock;
buffering said first packet, said second packet and said at least one forward error correction packet;
ordering said first packet and second packet based on a sequence number in said first packet and said second packet;
holding said first packet and said second packet in a buffer for a fixed latency to compensate for calculated network jitter;
removing said first packet and said second packet from said buffer and placing said first packet and said second packet in an error correction buffer for a fixed time;
recovering a first lost packet;
requesting resend of a second lost packet; and,
displaying multimedia using data obtained from said first packet, said second data packet, said first lost packet and said second lost packet.

17. The method of claim 16 further comprising:
responding to a network monitor packet received from a transmitter node.

18. The method of claim 17 further comprising:
calculating a minimum hold time based on network jitter and round-trip time calculated by said network monitor.

19. The method of claim 18 further comprising:
adjusting said a minimum hold time based on network jitter and round-trip time calculated by said network monitor.
